(19) United States
(12) Patent Application Publication
(10) Pub. No.: US 2018/0054082 A1
(43) Pub. Date: Feb. 22, 2018

(54) BATTERY POWERED ELECTRICAL OUTLET

(71) Applicant: TTI (MACAO COMMERCIAL OFFSHORE) LIMITED, Macau (MO)

(72) Inventor: Katrinka M. Mendenhall, Greenville, SC (US)

(21) Appl. No.: 15/679,219

(22) Filed: Aug. 17, 2017

Related U.S. Application Data
(60) Provisional application No. 62/377,215, filed on Aug. 19, 2016.

(51) Int. Cl. H02J 7/35; H02J 7/00; H02S 10/40

(52) U.S. Cl. CPC H02J 7/355; H02J 7/0054; H01M 10/46; H02J 7/0042; H02S 10/40

(57) ABSTRACT

A portable electrical outlet is selectively coupled to an electrical device and a rechargeable power tool battery pack. The power tool battery pack is configured to power the electrical device when the power tool battery pack and the electrical device are coupled to the portable electrical outlet. The portable electrical outlet includes a housing and an electrical socket coupled to the housing. The electrical socket includes a first aperture and a second aperture. The first aperture is configured to receive a first electrical prong of the electrical device, and the second aperture is configured to receive a second electrical prong of the electrical device. The portable electrical outlet includes a battery holder formed on a side of the housing. The battery holder includes a terminal. The battery holder is configured to support the power tool battery pack for the power tool battery pack to be electrically coupled to the terminal.

### CROSS-REFERENCE TO RELATED APPLICATIONS

This application claims priority to U.S. Provisional Patent Application No. 62/377,215, filed Aug. 19, 2016, the content of which is incorporated herein by reference.

### FIELD OF DISCLOSURE

The present disclosure relates to a portable electrical outlet. In particular, the present disclosure relates to a portable electrical outlet that is powered by a rechargeable power tool battery pack.

### SUMMARY

In one aspect, a portable electrical outlet is selectively coupled to an electrical device and a rechargeable power tool battery pack. The rechargeable power tool battery pack is configured to power the electrical device when the rechargeable power tool battery pack and the electrical device are coupled to the portable electrical outlet. The portable electrical outlet includes a housing and an electrical socket coupled to the housing. The electrical socket includes a first aperture and a second aperture. The first aperture is configured to receive a first electrical prong of the electrical device, and the second aperture is configured to receive a second electrical prong of the electrical device. The portable electrical outlet also includes a battery holder formed on a side of the housing. The battery holder includes a terminal. The battery holder is configured to support the rechargeable power tool battery pack for the rechargeable power tool battery pack to be electrically coupled to the terminal.

In another aspect, a portable electrical outlet is selectively coupled to an electrical device and a rechargeable power tool battery pack. The rechargeable power tool battery pack is configured to power the electrical device when the rechargeable power tool battery pack and the electrical device are coupled to the portable electrical outlet. The portable electrical outlet includes a housing having a post. The post is configured to be removably inserted into a surface to support the housing above the surface. The portable electrical outlet also includes an electrical socket coupled to the housing. The electrical socket includes an aperture. The aperture is configured to receive an electrical prong of the electrical device. The portable electrical outlet further includes a battery holder formed on a side of the housing. The battery holder includes a cavity and a terminal. The cavity is configured to receive the rechargeable power tool battery pack for the rechargeable power tool battery pack to be electrically coupled to the terminal.

In yet another aspect, a portable electrical outlet assembly is configured to power an electrical device. The portable electrical outlet assembly includes a rechargeable power tool battery pack and a portable electrical outlet. The portable electrical outlet includes a housing and an electrical socket coupled to the housing. The electrical socket includes a first aperture and a second aperture. The first aperture is configured to receive a first electrical prong of the electrical device, and the second aperture is configured to receive a second electrical prong of the electrical device. The portable electrical outlet also includes a battery holder formed on a side of the housing. The battery holder includes a terminal. The battery holder is configured to support the rechargeable power tool battery pack for the rechargeable power tool battery pack to be electrically coupled to the terminal. The rechargeable power tool battery pack is configured to power the electrical device when the rechargeable power tool battery pack and the electrical device are coupled to the portable electrical outlet.

Other aspects of the disclosure will become apparent by consideration of the detailed description and accompanying drawings.

### BRIEF DESCRIPTION OF THE DRAWINGS

FIG. 1 is a perspective view of an electrical device coupled to a portable electrical outlet according to an embodiment of the disclosure.

FIG. 2 illustrates a rechargeable power tool battery pack selectively coupled to the portable electrical outlet of FIG. 1 or a power tool.

FIG. 3 is a front perspective view of the portable electrical outlet of FIG. 1 according to one embodiment of the disclosure.

FIG. 4 is a rear perspective view of the portable electrical outlet of FIG. 3.

FIG. 5 is an electrical circuit schematic of the portable electrical outlet of FIG. 1 including a solar panel operable to charge the rechargeable power tool battery pack.

FIG. 6 is a front perspective view of the portable electrical outlet of FIG. 1 according to another embodiment of the disclosure.

FIG. 7 is a rear perspective view of the portable electrical outlet of FIG. 6.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways.

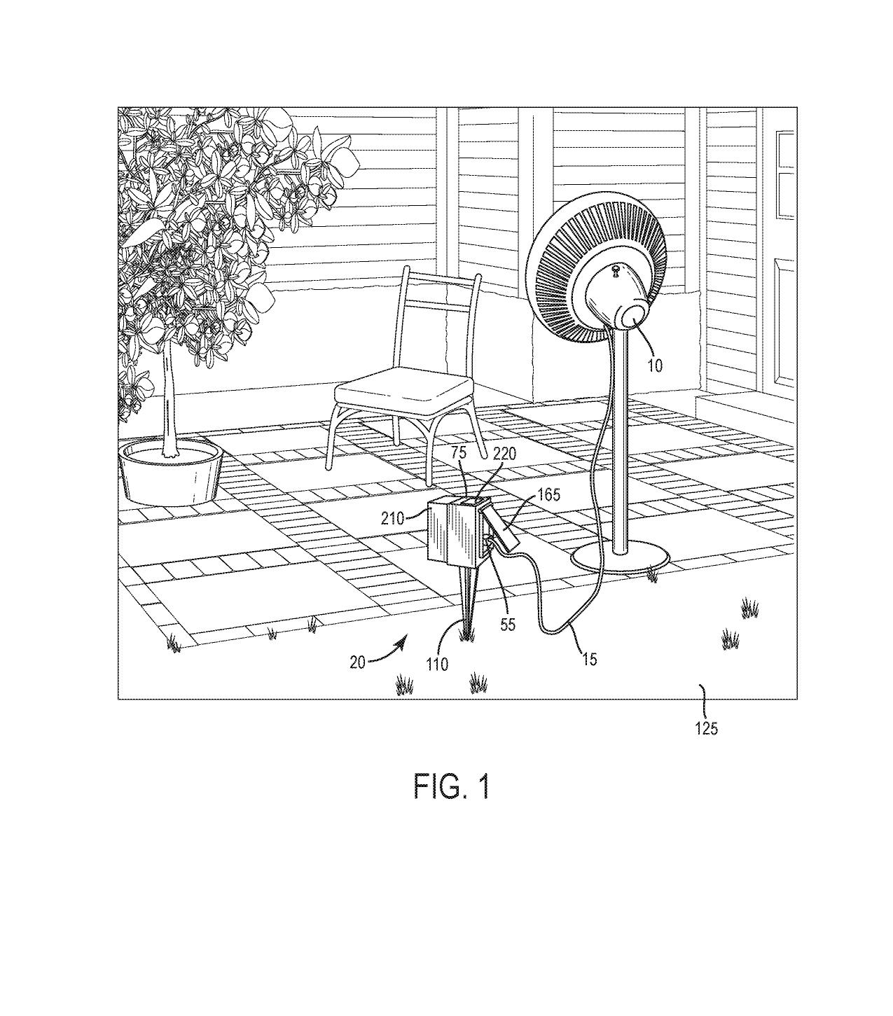

FIG. 1 illustrates an electrical device 10 including an electrical cord 15 selectively coupled to a portable electrical outlet 20. In the illustrated embodiment, the electrical device 10 is a fan, but can be other corded electrical devices (e.g., a light, holiday decorations such as Christmas lights, a misting device, a radio, a power tool, a laptop coupled to a charging cord, a smartphone coupled to a charging cord, a tablet coupled to a charging cord, etc.).

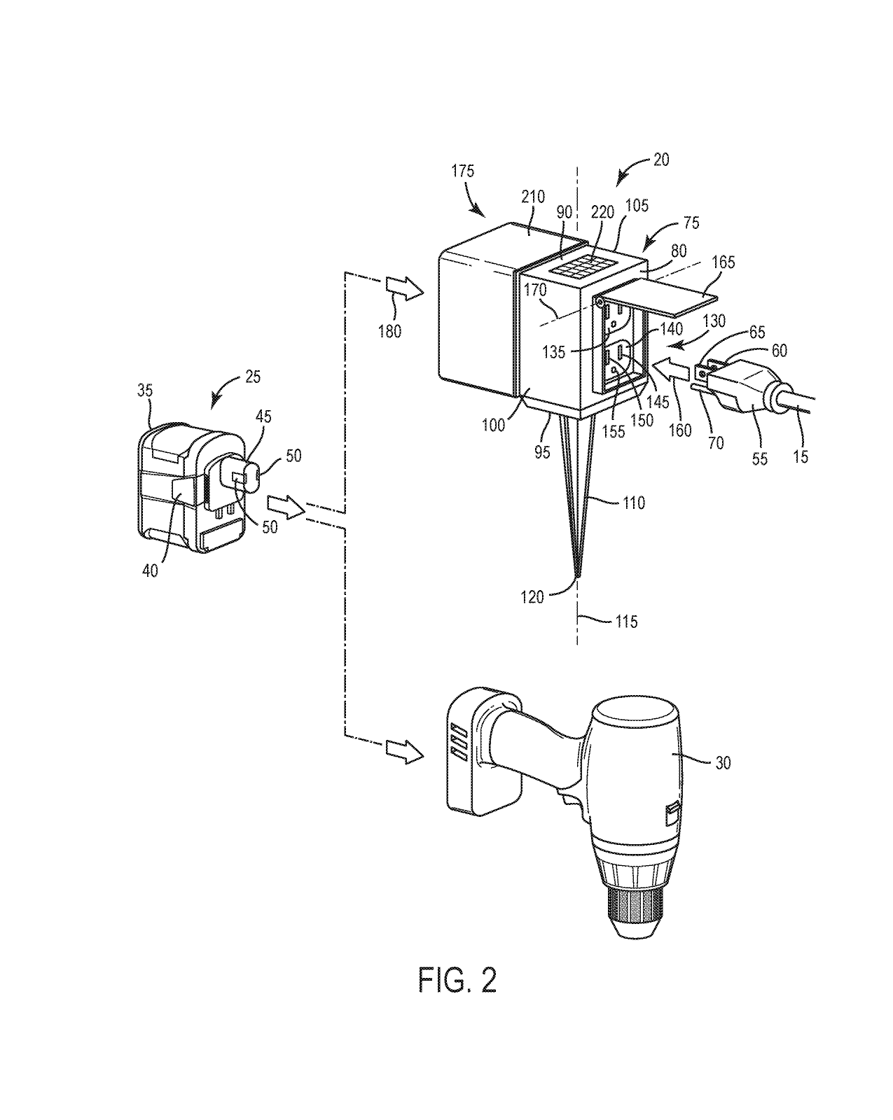

With reference to FIG. 2, a rechargeable power tool battery pack 25 is also selectively coupled to the portable electrical outlet 20 for the battery pack 25 to power the electrical device 10, discussed in more detail below. In one embodiment, a portable electrical outlet assembly includes the portable electrical outlet 20 and the rechargeable power tool battery pack 25. When the battery pack 25 is not coupled to the portable electrical outlet 20, the battery pack 25 can alternatively be selectively coupled to a power tool 30 (e.g., a drill, a hammer drill, a circular saw, a reciprocating saw, etc.) to power the power tool 30. In the illustrated embodiment, the battery pack 25 includes a nominal voltage of at least 10 volts. In other embodiments, the battery pack 25 can include a nominal voltage of about 12 volts or about 18 volts. The illustrated battery pack 25 includes a body 35 that supports lithium-ion battery cells and has latches 40 (only one latch 40 is illustrated in FIG. 2) to selectively couple the battery pack 25 to the portable electrical outlet 20 or the power tool 30. The battery pack 25 also includes a stem 45 coupled to and extends away from the body 35 with the stem 45 having battery terminals 50 that are electrically coupled to the lithium-ion battery cells. In other embodiments, the body 35 can support other types of battery cells (e.g., nickel-cadmium battery cells, etc.) to power the electrical device 10 and the power tool 30. Further, the battery pack 25 may include other types of coupling mechanisms (e.g., rails) instead of the stem 45 so that the battery pack 25 is a slide-on-style battery pack rather than a tower- or insert-style battery pack.

With continued reference to FIG. 2, the electrical cord 15 of the electrical device 10 includes a plug 55 having a first prong 60, a second prong 65, and a ground prong 70. As such, the illustrated plug 55 can be a Type B plug. In other embodiments, the plug 55 can be other types (e.g., Type A-O). In further embodiments, the plug 55 can be a Universal Serial Bus (USB) plug.

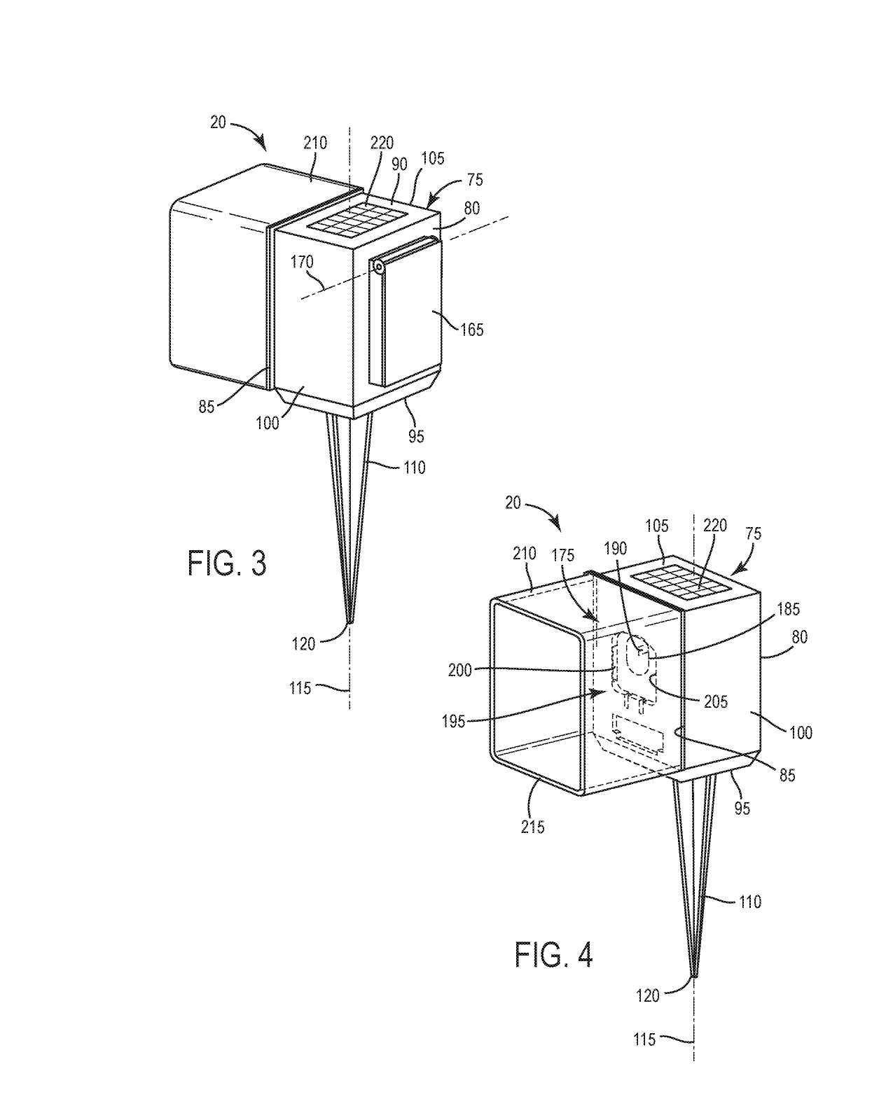

With reference to FIGS. 3 and 4, the portable electrical outlet 20 includes a housing 75 (e.g., a moisture resistant housing) having a front side 80, a rear side 85 opposite the front side 80, a top side 90, a bottom side 95 opposite the top side 90, a first side 100, and a second side 105 opposite the first side 100. A post 110 that defines a longitudinal axis 115 is coupled to and extends from the bottom side 95. The illustrated post 110 tapers from the bottom side 95 to an end or point 120 of the post 110 distal to the bottom side 95. The post 110 is operable to be removably inserted into a surface 125 (e.g., ground; FIG. 1) so that the housing 75 is supported above the surface 125. In other embodiments, the post 110 can be coupled to the first side 100 and/or the second side 105 of the housing 75. In further embodiments, the post 110 may be replaced with other types of stands for supporting the outlet 20 on a surface. For example, alternative stands may include a tripod base, a weighted base, a magnetized base, an adhesive base, and the like.

As best shown in FIG. 2, a pair of electrical sockets 130 is coupled to the front side 80 of the housing 75. A first electrical socket 135 and a second electrical socket 140 of the pair of electrical sockets 130 both include a first aperture 145, a second aperture 150, and a ground aperture 155 (e.g., a Type B socket). Each electrical socket 135, 140 is sized to receive the plug 55 of the electrical device 10. In particular, the first aperture 145 receives the first prong 60, the second aperture 150 receives the second prong 65, and the ground aperture 155 receives the ground prong 70. As such, the plug 55 is insertable into or removable out of one of the first and second electrical sockets 135, 140 in a first direction 160 (FIG. 2) that is substantially perpendicular to the longitudinal axis 115 of the post 110. In other embodiments, at least one of the first and second electrical sockets 135, 140 can be coupled to the first side 100 or the second side 105 of the housing 75, which would still maintain the first direction 160 to be substantially perpendicular to the longitudinal axis 115. However, in further embodiments, at least one of the first and second electrical sockets 135, 140 can be coupled to the top side 90 of the housing 75, which would alter the first direction 160 to be substantially parallel with the longitudinal axis 115. In some embodiments, both the first and second electrical sockets 135, 140 can be different types of sockets (e.g., Type A-O). In other embodiments, the first electrical socket 135 can be one type of socket (e.g., Type B) and the second electrical socket 140 can be another type of socket (e.g., USB socket).

A socket cover 165 is pivotably coupled to the front side 80 of the housing 75 about an axis 170 between an open position (FIGS. 1 and 2) that allows access to the pair of electrical sockets 130 and a closed position (FIG. 3) to block access to the pair of electrical sockets 130. The illustrated axis 170 is substantially perpendicular to the longitudinal axis 115 of the post 110, but in other embodiments, the axis 170 can be substantially parallel to the longitudinal axis 115. A moisture resistant seal can also be provided between the socket cover 165 and the front side 80 of the housing 75 to protect the pair of electrical sockets 130 from moisture when the socket cover 165 is in the closed position. In other embodiments, the socket cover 165 may be omitted.

As best shown in FIG. 4, a battery holder 175 is formed on the rear side 85 of the housing 75 and is sized to receive the battery pack 25. In particular, the battery pack 25 is insertable into or removable out of the battery holder 175 in a second direction 180 (FIG. 2), which is opposite to the first direction 160. In other words, the second direction 180 is parallel to the first direction 160. In other embodiments, the battery holder 175 can be coupled to the first side 100 or the second side 105 of the housing 75, which would still maintain the second direction 180 to be substantially perpendicular to the longitudinal axis 115. However, in further embodiments, the battery holder 175 can be coupled to the top side 90 of the housing 75, which would alter the second direction 180 to be substantially parallel with the longitudinal axis 115. In other words, the second direction 180 is perpendicular to the first direction 160.

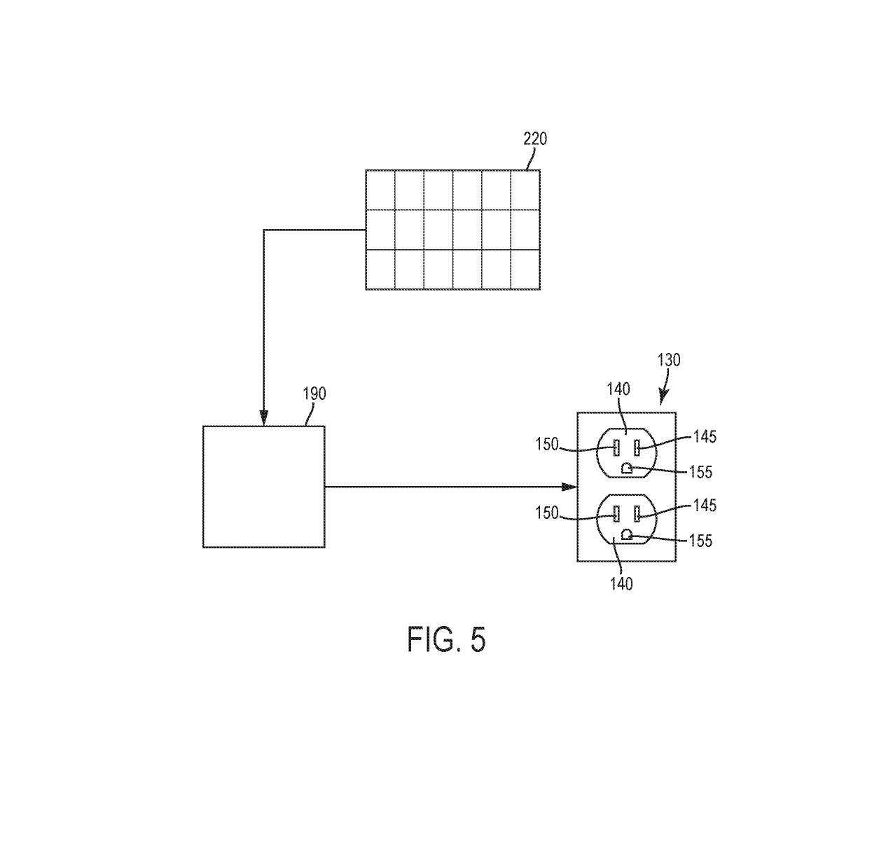

The illustrated battery holder 175 includes a cavity 185 with outlet terminals 190 (only one outlet terminal 190 is illustrated in FIG. 4) located within the cavity 185 with the outlet terminals 190 electrically coupled to the pair of electrical sockets 130 (FIG. 5). The battery holder 175 also includes a latching arrangement 195 sized to receive the latches 40 of the battery pack 25. The illustrated latching arrangement 195 includes a first aperture 200 and a second aperture 205 located on opposing sides of the cavity 185. With continued reference to FIG. 4, a battery cover 210 is fixedly coupled to the rear side 85 of the housing 75 to extend away from the battery holder 175 and includes an opening 215 in which the battery pack 25 is received through to engage the battery holder 175. In some embodiments, a pivotable cover (similar to the socket cover 165) can be coupled to the battery cover 210 to allow access to the battery holder 175 when in an open position and not allow access to the battery holder 175 but provide a moisture resistant seal when in a closed position. In other embodiments, the battery cover 210 may be omitted.

The illustrated portable electrical outlet 20 also includes at least one solar panel 220 coupled to the top side 90 of the housing 75 (FIGS. 2-4) and is electrically coupled to the outlet terminals 190 (FIG. 5). Moreover, because the outlet terminals 190 are electrically coupled to the pair of electrical sockets 130, the solar panel 220 is also electrically coupled to the pair of electrical sockets 130 by the outlet terminals 190. In other embodiments, the solar panel 220 can be directly coupled to the pair of electrical sockets 130 and the outlet terminals 190. In further embodiments, the solar panel 220 can be coupled to another side of the housing 75 (e.g., the first side 100 or the second side 105), can extend onto a side of the battery cover 210, and/or multiple solar panels 220 can be coupled to multiple sides of the housing 75. The portable electrical outlet 20 can also include suitable electrical components to convert and/or regulate electrical current traveling from the solar panel 220 to the outlet terminals 190 and/or traveling from the outlet terminals 190 to the pair of electrical sockets 130 (e.g., a DC to AC power converter can be electrically coupled between the outlet terminals 190 and the pair of electrical sockets 130). In other embodiments, the solar panel 220 can be omitted from the portable electrical outlet 20.

In operation, the portable electrical outlet 20 is placed at a desired location on the surface 125 by sticking the post 110 into the surface 125. For example, FIG. 1 illustrates the portable electrical outlet 20 supported above a residential yard adjacent an outdoor patio area. To connect the battery pack 25 to the portable electrical outlet 20, the battery pack 25 is moved along the second direction 180 through the opening 215 of the battery cover 210 to engage with the battery holder 175. In particular, the stem 45 of the battery pack 25 is received within the cavity 185 for the battery terminals 50 to connect with the outlet terminals 190. Once the battery terminals 50 connect with the outlet terminals 190, the battery pack 25 energizes the pair of electrical sockets 130. In other embodiments, an ON/OFF switch can be coupled to the housing 75 and is operable to selectively energize the pair of electrical sockets 130 after the battery terminals 50 are connected to the outlet terminals 190. In addition to the battery terminals 50 connecting with the outlet terminals 190, the latches 40 of the battery pack 25 engage with the latching arrangement 195 of the portable electrical outlet 20. In particular, a portion of the latches 40 extends through the first and second apertures 200, 205 and engages the rear side 85 of the housing 75 to lock the battery pack 25 to the portable electrical outlet 20.

The electrical device 10 is powered by the battery pack 25 by inserting the plug 55 into one of the first and second electrical sockets 135, 140 along the first direction 160.

In the illustrated embodiment, the solar panel 220 is operable to charge the battery pack 25 when it is coupled to the battery holder 175. For example, once the battery terminals 50 contact the outlet terminals 190, the solar panel 220 automatically begins to supply the battery pack 25 with direct electrical current (i.e., DC power) to increase the voltage level (e.g., to charge) the battery pack 25. If the plug 55 is not coupled to the first and second sockets 135, 140, all of the DC power from the solar panel 220 is received by the battery pack 25 to charge the battery pack 25. However, if the plug 55 is coupled to one of the first and second sockets 135, 140, then all of the DC power from the solar panel 220 is directed toward the pair of electrical sockets 130 to help the battery pack 25 power the electrical device 10. In other embodiments, the DC power from the solar panel 220 can charge the battery pack 25 simultaneously as the battery pack 25 is powering the electrical device 10. In further embodiments, the DC power from the solar panel 220 can directly power the electrical device 10 (e.g., Christmas lights) when the battery pack 25 is detached from the portable electrical outlet 20.

To remove the battery pack 25 from the portable electrical outlet 20 to, for example, recharge the battery pack 25 or to power the power tool 30, the latches 40 are depressed allowing the latches 40 to disengage from the latching arrangement 195. Thereafter, the battery pack 25 is moved along the second direction 180 and away from the rear side 85 of the housing 75 to disengage the battery pack 25 from the portable electrical outlet 20. As such, the battery cover 210 is sized to provide enough clearance on both sides of the battery pack 25 to allow for an operator's fingers to be positioned between the battery cover 210 and the battery pack 25 to depress the latches 40.

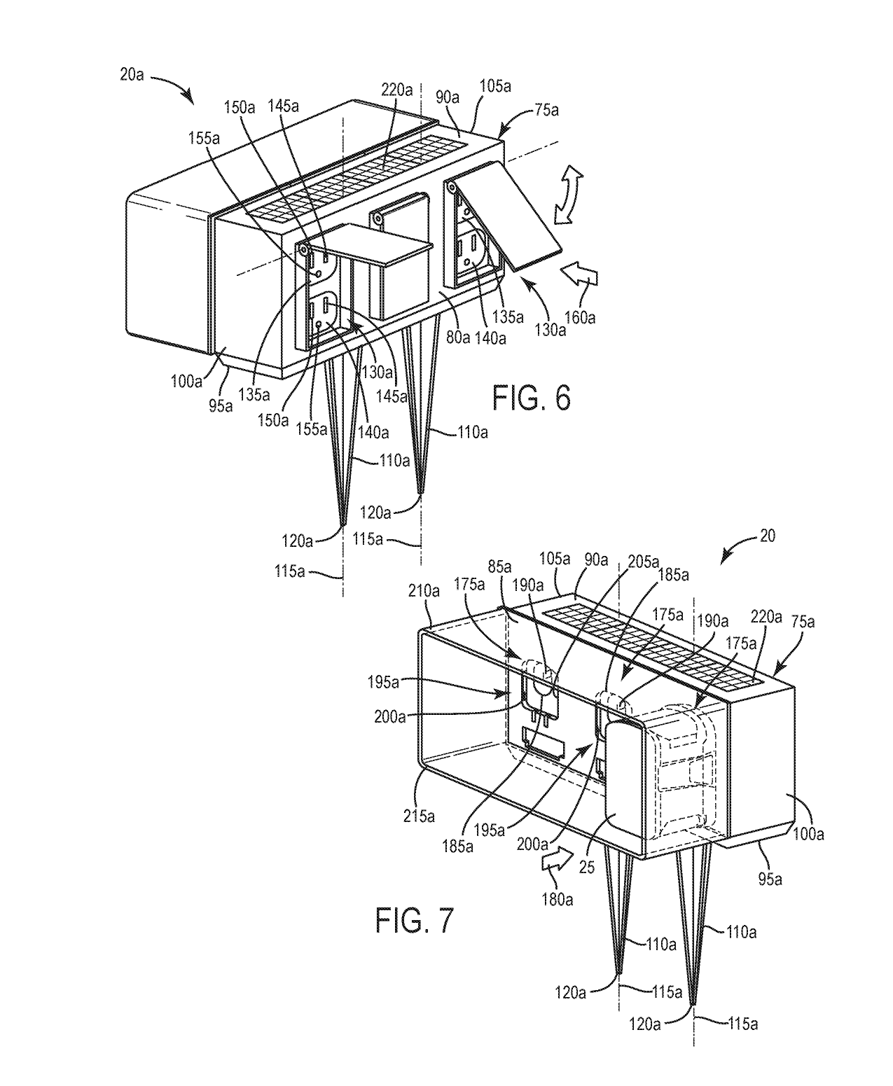

FIGS. 6 and 7 illustrate a portable electrical outlet 20a according to another embodiment of the disclosure. The portable electrical outlet 20a is similar to the portable electrical outlet 20; therefore, like components have been given like references numbers including the letter “a” and only the differences between the portable electrical outlets 20, 20a will be discussed in detail. In addition, components or features described with respect to only one or some of the embodiments described herein are equally applicable to any other embodiments described herein.

The portable electrical outlet 20a includes a housing 75a having a front side 80a, a rear side 85a, a top side 90a, a bottom side 95a, a first side 100a, a second side 105a, and at least two posts 110a each defining a longitudinal axis 115a and having an end 120a. Three pairs of electrical sockets 130a are coupled to the front side 80a and each pair includes a first electrical socket 135a and a second electrical socket 140a both having a first aperture 145a, a second aperture 150a, and a ground aperture 155a. The portable electrical outlet 20a also includes socket covers 165a each associated with one of the pairs of electrical sockets 130a. Each socket cover 165a is independently moveable relative to the other socket covers 165a. When a socket cover 165a is in an open position (e.g., outer two socket covers 165a illustrated in FIG. 6), the plug 55 is insertable into or removable out of one of the first and second electrical sockets 135a, 140a in a first direction 160a.

As best shown in FIG. 7, three battery holders 175a are formed on the rear side 85a of the housing 75a and each is sized to receive one battery pack 25 along a second direction 180a. Each battery holder 175a includes a cavity 185a with outlet terminals 190a located within the cavity 185a (only one outlet terminal 190a is illustrated for each battery holder 175a in FIG. 7). Each battery holder 175a also includes a latching arrangement 195a having a first aperture 200a and a second aperture 205a. With continued reference to FIG. 7, a battery cover 210a surrounds all three battery holders 175a and includes an opening 215a in which three battery packs 25 are received through to each engage one of the battery holders 175a. The portable electrical outlet 20a also includes a solar panel 220a coupled to the top side 90a of the housing 75a.

In operation, when a first battery pack 25 engages a first battery holder 175a so that the battery terminals 50 connect with the outlet terminals 190a, the first battery pack 25 energizes a single pair of electrical sockets 130a, which is associated with the first battery holder 175a. As such, the other two pairs of electrical sockets 130a are not electrically coupled to the first battery pack 25 and are not energized. The other two pairs of electrical sockets 130a are energized once second and third battery packs 25 are coupled to the battery holders 175a associated with these two pairs of electrical sockets 130a. In other embodiments, a single battery pack 25 can energize all three pairs of electrical sockets 130a once the single battery pack 25 is coupled to any one of the three battery holders 175a.

Although the disclosure has been described with reference to certain preferred embodiments, variations and modifications exist within the scope and spirit of one or more independent aspects of the disclosure as described. Various features and advantages of the invention are set forth in the following claims.

1. A portable electrical outlet selectively coupled to an electrical device and a rechargeable power tool battery pack, the rechargeable power tool battery pack configured to power the electrical device when the rechargeable power tool battery pack and the electrical device are coupled to the portable electrical outlet, the portable electrical outlet comprising:
a housing;
an electrical socket coupled to the housing, the electrical socket including a first aperture and a second aperture, the first aperture configured to receive a first electrical prong of the electrical device and the second aperture configured to receive a second electrical prong of the electrical device; and
a battery holder formed on a side of the housing, the battery holder including a terminal, the battery holder configured to support the rechargeable power tool battery pack for the rechargeable power tool battery pack to be electrically coupled to the terminal.

2. The portable electrical outlet of claim 1, further comprising a stand coupled to the housing, wherein the stand is configured to support the housing on a surface.

3. The portable electrical outlet of claim 2, wherein the stand is a post defining a longitudinal axis, and wherein the post is configured to be removably inserted into the surface to support the housing above the surface.

4. The portable electrical outlet of claim 3, wherein the rechargeable power tool battery pack is configured to be insertable into a cavity of the battery holder in a direction perpendicular to the longitudinal axis.

5. The portable electrical outlet of claim 3, wherein the first and second electrical prongs are configured to be insertable into the first and second apertures in a direction perpendicular to the longitudinal axis.

6. The portable electrical outlet of claim 1, wherein the housing includes a cover configured to be moveable between a first position to allow access to the electrical socket and a second position to block access to the electrical socket.

7. The portable electrical outlet of claim 1, further comprising a solar panel coupled to the housing, wherein the solar panel is electrically coupled to the terminal of the battery holder, and wherein the solar panel is configured to charge the rechargeable power tool battery pack when the rechargeable power tool battery pack is coupled to the battery holder.

8. The portable electrical outlet of claim 1, wherein the electrical socket is a first electrical socket, and wherein the portable electrical outlet further includes a second electrical socket coupled to the housing.

9. The portable electrical outlet of claim 8, wherein the first and second electrical sockets are configured to be energized by a single rechargeable power tool battery pack.

10. The portable electrical outlet of claim 8, wherein the first and second electrical sockets define a pair of electrical sockets, and wherein the portable electrical outlet further includes two pairs of electrical sockets.

11. The portable electrical outlet of claim 10, wherein the housing includes a first cover configured to be moveable between a first position to allow access to the first pair of electrical sockets and a second position to block access to the first pair of electrical sockets, and wherein the housing includes a second cover configured to be moveable between a first position to allow access to the second pair of electrical sockets and a second position to block access to the second pair of electrical sockets, and wherein the first and second covers are configured to be independently moveable relative to each other.

12. A portable electrical outlet selectively coupled to an electrical device and a rechargeable power tool battery pack, the rechargeable power tool battery pack configured to power the electrical device when the rechargeable power tool battery pack and the electrical device are coupled to the portable electrical outlet, the portable electrical outlet comprising:
a housing including a post, the post configured to be removably inserted into a surface to support the housing above the surface;
an electrical socket coupled to the housing, the electrical socket including an aperture, the aperture configured to receive an electrical prong of the electrical device; and
a battery holder formed on a side of the housing, the battery holder including a cavity and a terminal, the cavity configured to receive the rechargeable power tool battery pack for the rechargeable power tool battery pack to be electrically coupled to the terminal.

13. The portable electrical outlet of claim 12, further comprising a solar panel coupled to the housing, wherein the solar panel is electrically coupled to the terminal of the battery holder, and wherein the solar panel is configured to charge the rechargeable power tool battery pack when the rechargeable power tool battery pack is coupled to the battery holder.

14. The portable electrical outlet of claim 12, wherein the post defines a longitudinal axis, and wherein the rechargeable power tool battery pack is configured to be insertable into the cavity of the battery holder in a direction perpendicular to the longitudinal axis, and wherein the electrical prong is configured to be insertable into the aperture in a direction perpendicular to the longitudinal axis.

15. The portable electrical outlet of claim 12, wherein the housing includes a cover configured to be moveable between a first position to allow access to the electrical socket and a second position to block access to the socket.

16. The portable electrical outlet of claim 12, wherein the electrical socket is a first electrical socket, and wherein the portable electrical outlet further includes a second electrical socket coupled to the housing.

17. The portable electrical outlet of claim 16, wherein the first and second electrical sockets are configured to be energized by a single rechargeable power tool battery pack.

18. The portable electrical outlet of claim 16, wherein the first and second electrical sockets define a pair of electrical sockets, and wherein the portable electrical outlet further includes two pairs of electrical sockets.

19. The portable electrical outlet of claim 18, wherein the housing includes a first cover configured to be moveable between a first position to allow access to the first pair of electrical sockets and a second position to block access to the first pair of electrical sockets, and wherein the housing includes a second cover configured to be moveable between a first position to allow access to the second pair of electrical sockets and a second position to block access to the second pair of electrical sockets, and wherein the first and second covers are configured to be independently moveable relative to each other.

20. A portable electrical outlet assembly configured to power an electrical device, the portable electrical outlet assembly comprising:
a rechargeable power tool battery pack; and
a portable electrical outlet including
a housing,
a stand coupled to the housing, the stand configured to support the housing on a surface,
an electrical socket coupled to the housing, the electrical socket including a first aperture and a second aperture, the first aperture configured to receive a first electrical prong of the electrical device and the second aperture configured to receive a second electrical prong of the electrical device, and
a battery holder formed on a side of the housing, the battery holder including a terminal, the battery holder configured to support the rechargeable power tool battery pack for the rechargeable power tool battery pack to be electrically coupled to the terminal;
wherein the rechargeable power tool battery pack is configured to power the electrical device when the rechargeable power tool battery pack and the electrical device are coupled to the portable electrical outlet.
